(19) United States
(12) Patent Application Publication
(10) Pub. No.: US 2025/0158207 A1
(43) Pub. Date: May 15, 2025

(54) HOUSING

(71) Applicant: DEUTZ Aktiengesellschaft, Cologne (DE)

(72) Inventors: Oliver Günther Hoffmann, Grafschaft (DE); Michael QUAST, Alsdorf (DE)

(21) Appl. No.: 18/835,053

(22) PCT Filed: Jan. 23, 2023
(86) PCT No.: PCT/EP2023/000006

§ 371 Date: Aug. 1, 2024

(30) Foreign Application Priority Data
Feb. 3, 2022 (DE) 10 2022 000 414.3

(51) Int. Cl. H01M 50/293; H01M 10/6557; H01M 50/204; H01M 50/271; H01M 50/291

(52) U.S. Cl. CPC H01M 50/293; H01M 10/6557; H01M 50/271; H01M 50/291; H01M 50/204

(57) ABSTRACT

The invention relates to a housing, in particular for an energy storage device, comprising an intermediate unit (2) with an intermediate element (3) in the form of a prism with an H-shaped base face (4) and a longitudinal axis (5), wherein the intermediate element (3) has a first side wall (6) on a first longitudinal side and a second side wall (11) on a second longitudinal side, between which a support section (16) extends, which spans a support plane (E_T), and an end unit (52), wherein the intermediate element (3) being connected to the end unit (52) at a respective first end (7, 12) of the first side wall (6) and of the second side wall (11) remote from the support section (16) in such a way that a first housing chamber (84) is formed between the intermediate unit (2) and the end unit (52).

The present invention relates to a housing, in particular for an energy storage device.

Housings for energy storage devices have the purpose of accommodating the energy storage device and protecting it from environmental influences. Furthermore, housings for energy storage devices can include interfaces for transferring electrical energy between individual batteries or to an electrical load.

DE 10 2017 216 782 A1 discloses a module housing for a vehicle battery which comprises a receiving element with a U-shaped cross-section for receiving a battery module, the receiving element being closed at the opposite front faces by a plate. The plate are connected to the receiving element via a tension strap.

In view of this, the object of the present invention is to provide a housing, in particular for an energy storage device, which enables simplified assembly.

To solve the problem a housing is proposed, in particular for an energy storage device, comprising an intermediate unit with an intermediate element in the form of a prism with an H-shaped base face and a longitudinal axis, wherein the intermediate element has a first side wall on a first longitudinal side and a second side wall on a second longitudinal side, between which a support section extends, which spans a support plane, and an end unit, wherein the intermediate element being connected to the end unit at a respective first end of the first side wall and of the second side wall remote from the support section in such a way that a first housing chamber is formed between the intermediate unit and the end unit.

By connecting the end unit to the remote ends of the first and second side walls and by the H-shaped design of the intermediate unit, accessibility to the energy storage device and the interfaces provided for operating the energy storage device is increased during assembly.

A prism in the context of the present invention is a geometric body described by parallel displacement of a plane polygon along a longitudinal axis not lying in this plane. A prism is produced, for example, by extrusion through a polygonal shaping opening. In this respect, the intermediate element can be produced by extrusion or extrusion molding. The intermediate element in the form of a prism within the meaning of the present invention should also be understood that the intermediate element has a prismatic basic shape which contains subsequently introduced machining operations, so that the intermediate element is prismatic at least partially. In this respect, the intermediate element can be produced by extrusion or extrusion molding and have subsequent machining operations.

The longitudinal side of the intermediate element should be understood as the sides of the intermediate element that are arranged parallel to the longitudinal axis. Accordingly, the front faces of the intermediate element are arranged transversely to the longitudinal axis and also to the longitudinal axes. Accordingly, the front faces can also be referred to as cross faces.

The support section spans the support plane in such a way that the support plane runs through the geometric center of gravity of the cross-sectional area of the support section.

In one possible embodiment, the first end of the first side wall remote from the support section may have a first end contact surface portion connected to the end unit. Alternatively, or in combination, a first end of the second side wall remote from the support section may have a second end contact surface portion connected to the end unit. The first end contact surface portion and the second end contact surface portion can lie in one end contact plane. The connection between the first end of the side walls and the end unit can be made directly, at least partially, so that the first end of the respective side wall is in contact with the end unit. Alternatively, the connection between the first end of the side walls and the end unit can be indirect, at least partially, whereby in particular a seal can be provided between the first end of the side walls and the end unit.

In a further possible embodiment, the intermediate element can be connected to a receiving unit at a second end of the first side wall and the second side wall opposite the first end. A second housing chamber can be formed between the intermediate unit and the receiving unit.

In addition, the second end of the first side wall can have a first receiving contact surface portion that is connected to the receiving unit. Alternatively or in combination, the second end of the second side wall can have a second receiving contact surface portion that is connected to the receiving unit. In this case, the first receiving contact surface portion and the second receiving contact surface portion can lie in a receiving contact plane. The connection between the second end of the side walls and the receiving unit can be made directly, at least partially, so that the second end of the respective side wall is in contact with the receiving unit. Alternatively, the connection between the second end of the side walls and the receiving unit can be indirect, at least partially, whereby in particular a seal can be provided between the second end of the side walls and the receiving unit.

The end contact plane and the support plane can be arranged in parallel and spaced apart by a first amount and/or the receiving contact plane and the support plane can be arranged in parallel and spaced apart by a second amount. In particular, the ratio of the first amount to the second amount can be at least 0.25, in particular at least 0.3. Alternatively or in combination, the ratio of the first amount to the second amount can be less than or equal to 4, in particular less than or equal to 3.

In a possible embodiment, the support section can comprise a channel that runs parallel to the longitudinal axis, at least partially. The channel can comprise a first channel section, which has an inlet opening at an inlet end, and a further channel section, which has an outlet opening at an outlet end, wherein the first channel section is fluidically connected at a connection end to a connection end of the further channel section.

Furthermore, the first channel section can comprise an inlet manifold section adjacent to the inlet opening and a connection manifold section at the connection end. The second channel section can comprise an outlet manifold section adjacent to the outlet opening and a connection manifold section at the connection end. It is possible that the connection manifold section of the first channel section is fluidically connected to the connection manifold section of the further channel section and, in particular, is integral with it. In particular, it is conceivable that the inlet manifold section and/or the connection manifold section of the first channel section is formed by a recess in the first channel section; and/or that the outlet manifold section and/or the connection manifold section of the further channel section is formed by a recess in the further channel section. The recesses in the first and further channel sections can each be made by inserting a finger cutter into the respective channel section. In particular, the finger cutter can be aligned so that the longitudinal axis of the finger cutter is parallel to the longitudinal axis of the prism.

In a further possible embodiment, the intermediate unit can comprise a first cover element and a second cover element. The first cover element can be connected to the intermediate element at a first front face of the intermediate element and the second cover element can be connected to the intermediate element at a second front face opposite the first front face. In particular, a first end of the first cover element remote from the support section may have a third end contact surface portion connected to the end unit; and a first end of the second cover element remote from the support section may have a fourth end contact surface portion connected to the end unit. In this case, the third end contact surface portion and the fourth end contact surface portion can be located in the common end contact plane. The connection between the first end of the cover elements and the end unit can be made directly, at least partially, so that the first end of the respective cover element is in contact with the end unit. Alternatively, the connection between the first end of the cover elements and the end unit can be indirect, at least partially, whereby in particular a seal can be provided between the first end of the cover elements and the end unit. In particular, the third end contact surface portion and the fourth end contact surface portion can form an annular end contact surface together with the first end contact surface portion and the second end contact surface portion.

Furthermore, a second end of the first cover element remote from the support section can have a third receiving contact surface portion which is connected to the receiving unit. A second end of the second cover element remote from the support section can have a fourth receiving contact surface portion which is connected to the receiving unit. In this case, the third receiving contact surface portion and the fourth receiving contact surface portion can lie in the receiving contact plane. The connection between the second end of the cover elements and the receiving unit can be made directly, at least partially, so that the second end of the respective cover element is in contact with the receiving unit. Alternatively, the connection between the second end of the cover elements and the receiving unit can be indirect, at least partially, whereby a seal can be provided in particular between the second end of the cover elements and the receiving unit. In particular, the third receiving contact surface portion and the fourth receiving contact surface portion can form an annular receiving contact surface with the first receiving contact surface portion and the second receiving contact surface portion.

Furthermore, one of the first cover element and the second cover element can comprise an inlet aperture which is directly adjacent to the inlet opening of the channel and merges into it. Alternatively or in combination, one of the first cover element and the second cover element can also comprise an outlet aperture which is directly adjacent to the outlet opening of the channel and merges into it. The inlet aperture and outlet aperture can each be intersected by the support plane and arranged outside the end contact plane and the receiving contact plane.

In addition, the first cover element and/or the second cover element can comprise a first welding aperture and a second welding aperture, which are each arranged in overlap with the support section. The channel can be arranged in a projection in the direction of the longitudinal axis between the first welding aperture and the second welding aperture.

Embodiments of the housing according to the invention are explained below with reference to the Figures. Herein

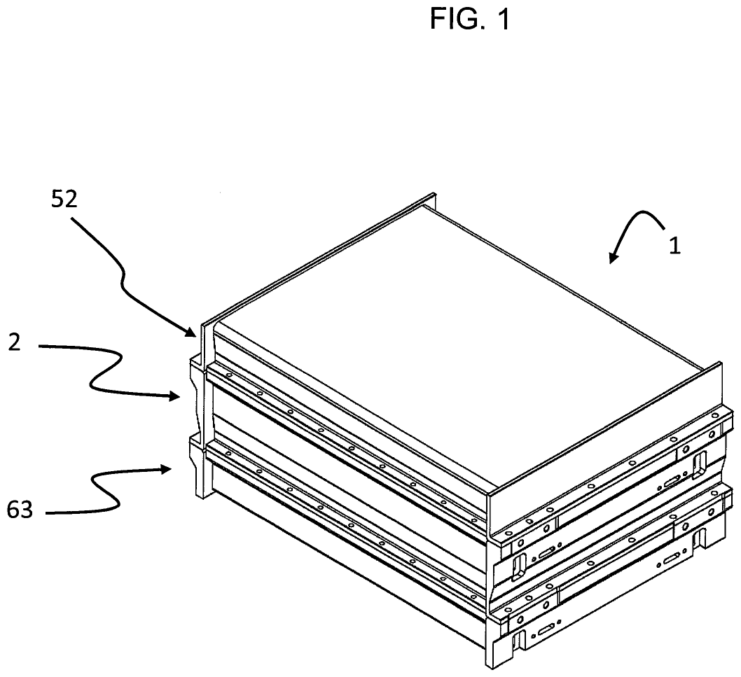

FIG. 1 is a perspective view of a housing for an energy storage device according to the invention in a first embodiment with an intermediate unit;

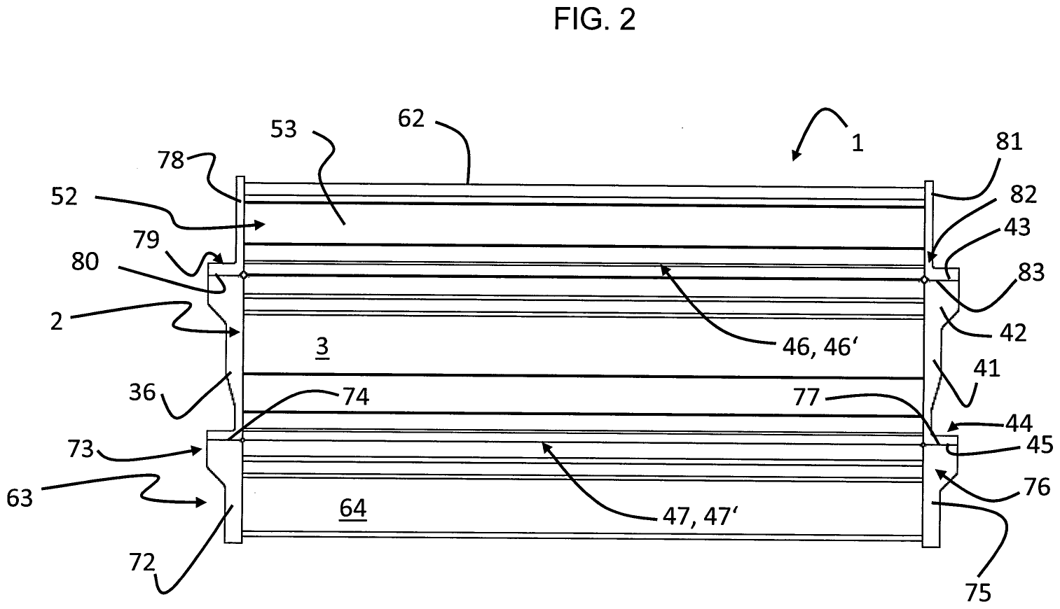

FIG. 2 is a side view of the housing according to FIG. 1;

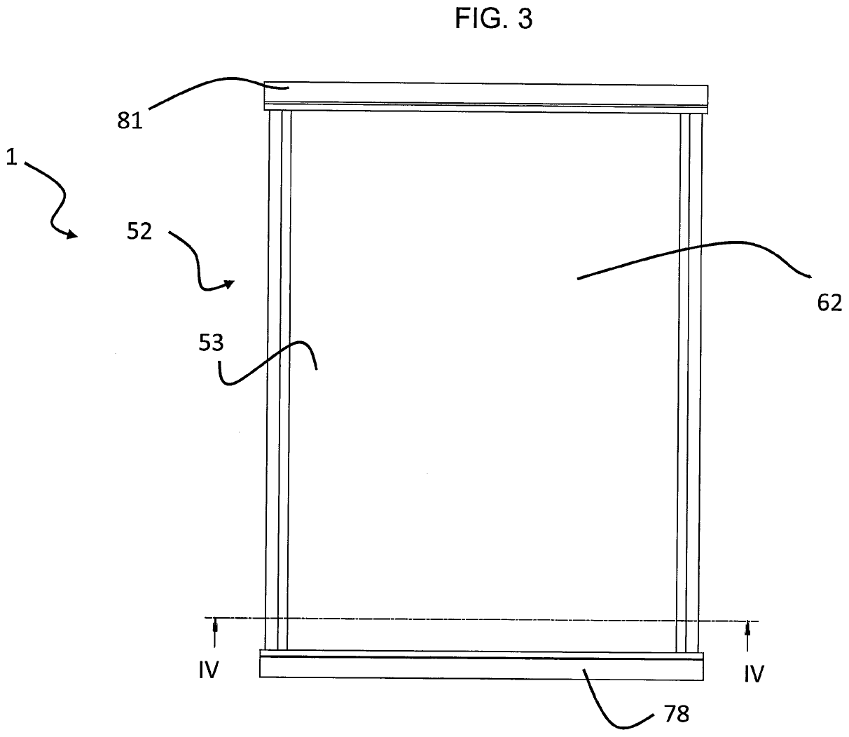

FIG. 3 is a plan view of the housing according to FIG. 1;

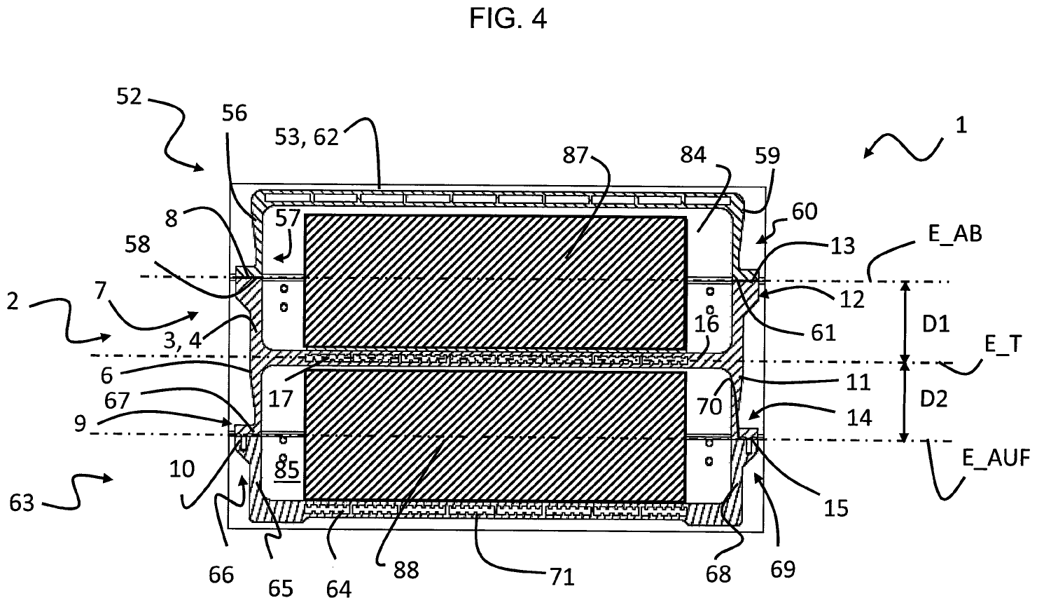

FIG. 4 is a cross-section of the housing according to FIG. 1 along the sectional line IV-IV according to FIG. 3;

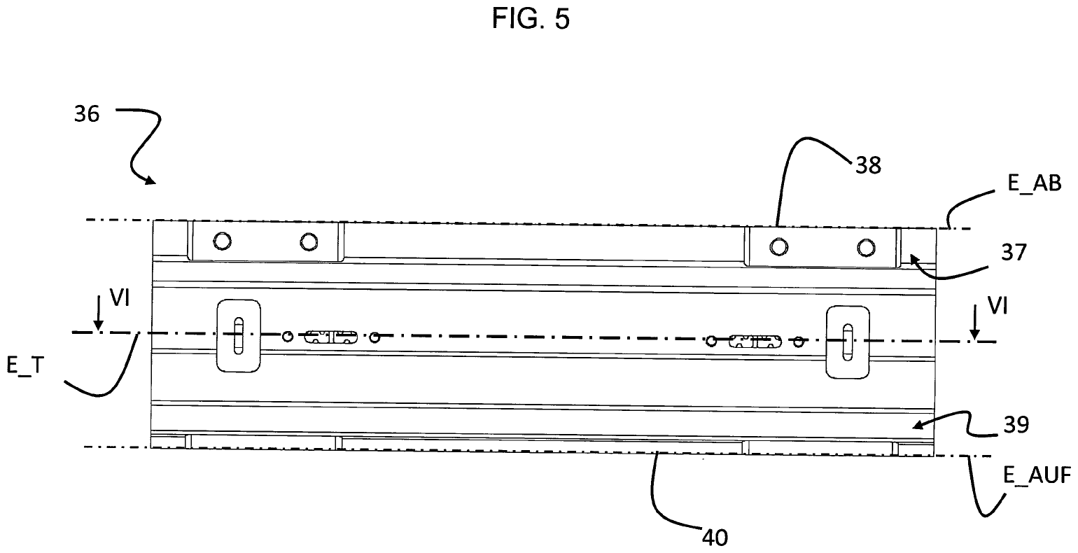

FIG. 5 is an front view of the intermediate unit of the housing according to FIG. 1;

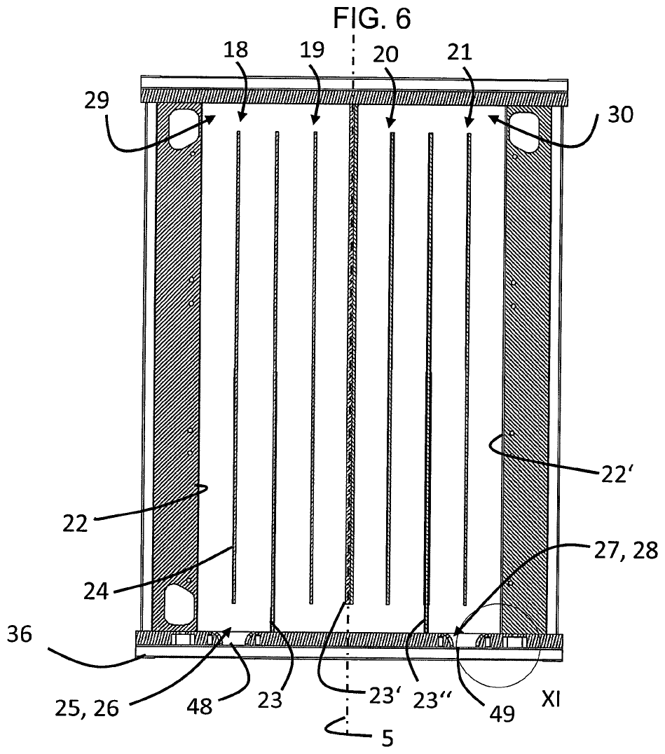

FIG. 6 a longitudinal section through the housing according to FIG. 1 along the section line VI-VI according to FIG. 5;

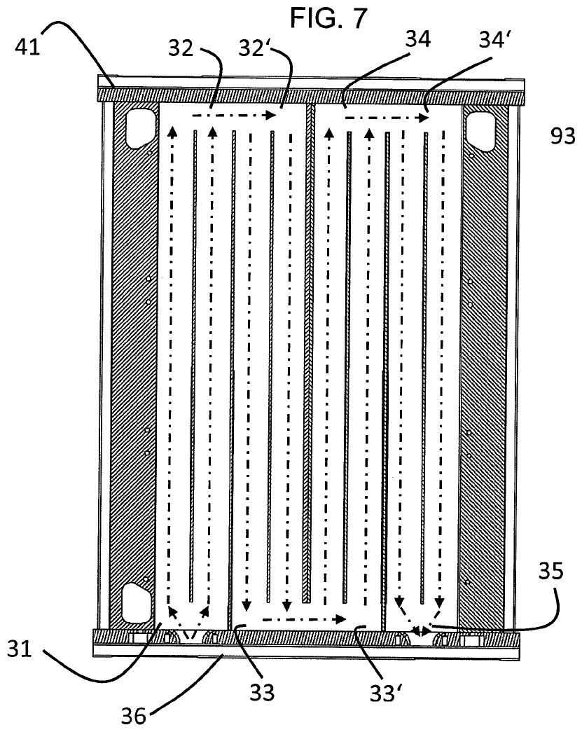

FIG. 7 the view according to FIG. 6 with dash-dotted arrows showing the direction of flow of coolant in the intermediate element of the housing according to FIG. 1;

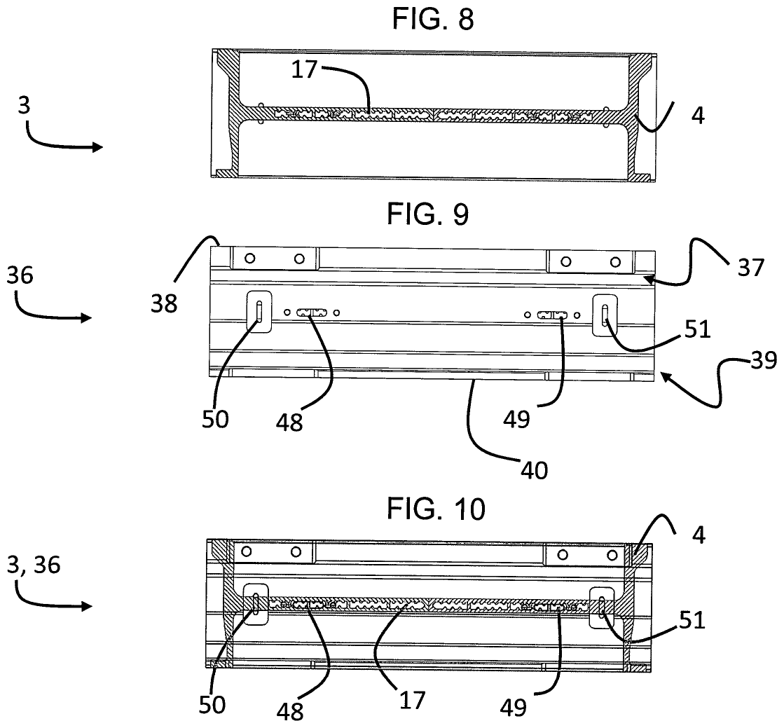

FIG. 8 a view of the front face of the intermediate element of the housing according to FIG. 1;

FIG. 9 the view according to FIG. 5 in the scale of FIG. 8;

FIG. 10 is a superimposition of FIGS. 8 and 9, with the view from FIG. 9 being shown partially transparent;

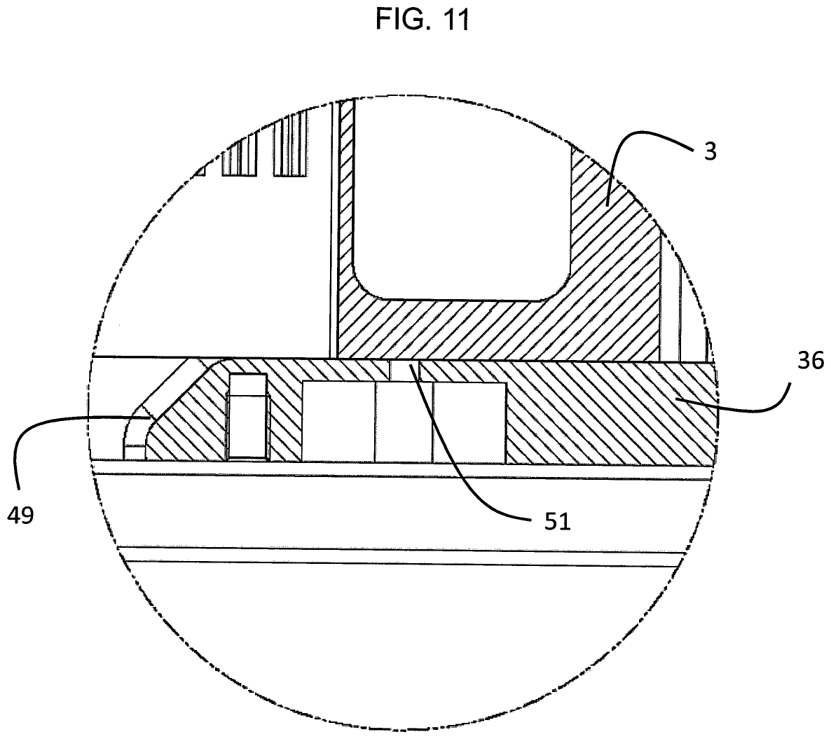

FIG. 11 is a detailed view of detail XI according to FIG. 6;

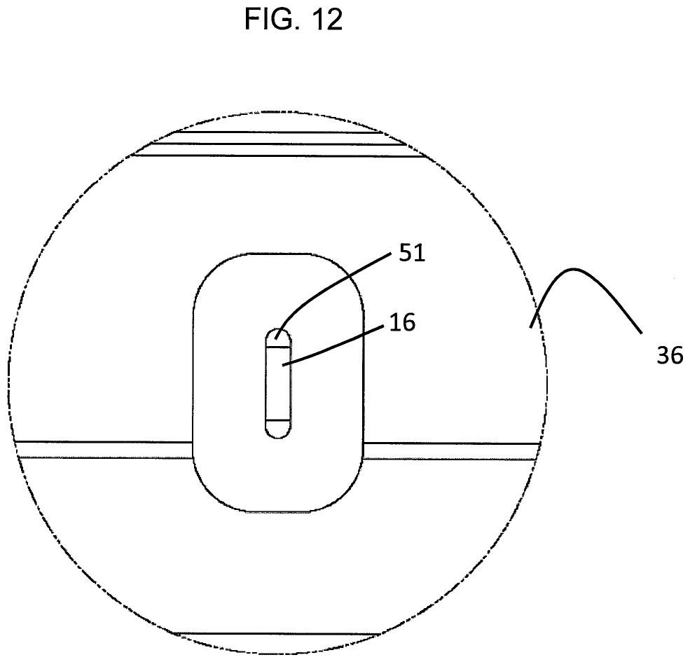

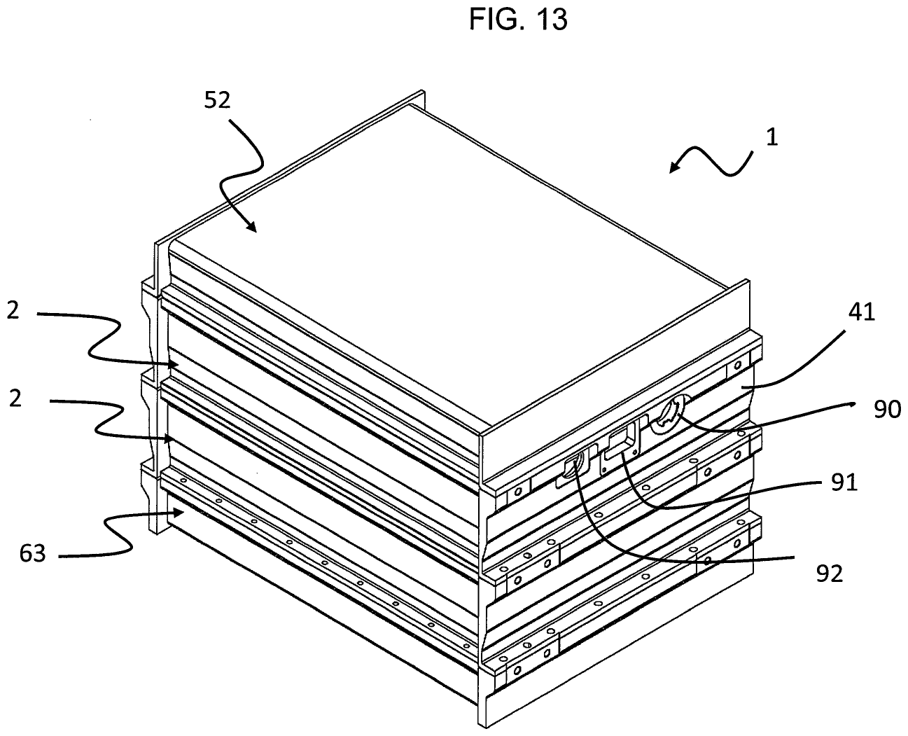

FIG. 12 is a detailed view of a welding aperture;

FIG. 13 is a perspective view of a housing according to the invention in a second embodiment with two intermediate units;

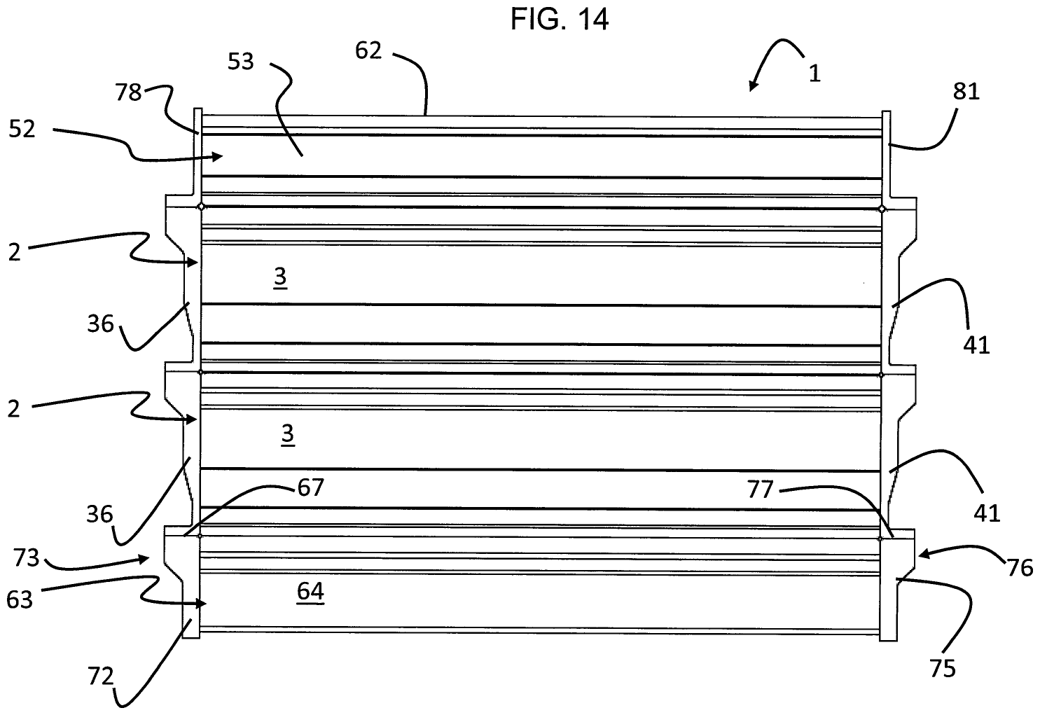

FIG. 14 is a plan view of the housing according to FIG. 13; and

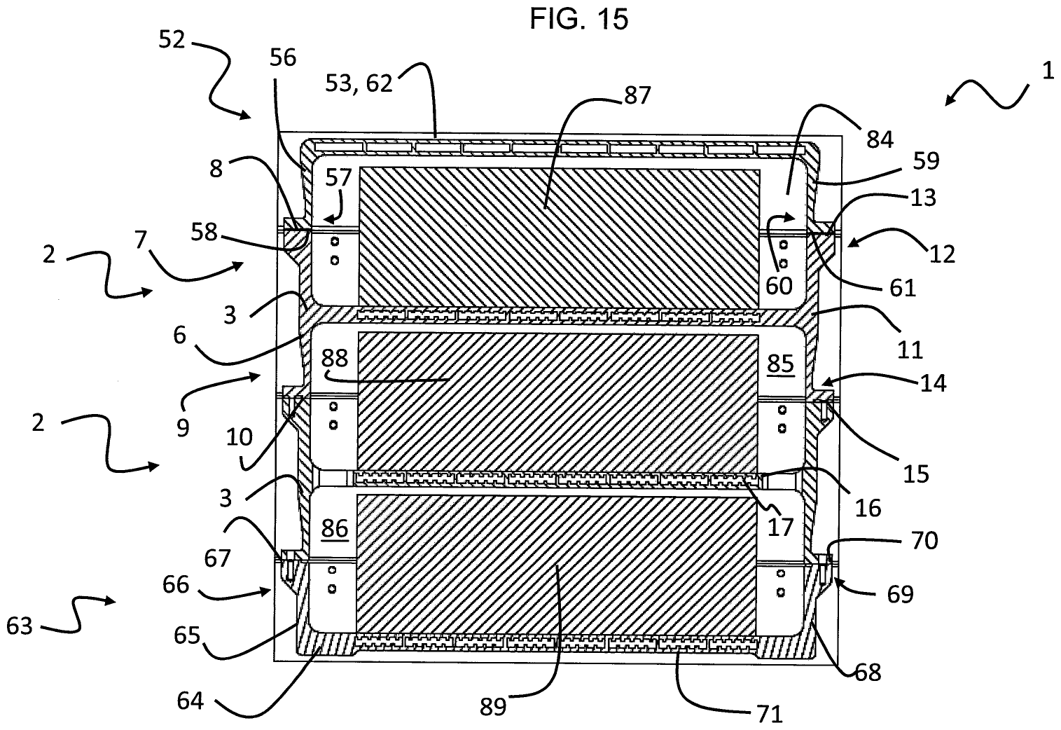

FIG. 15 is a plan view of the housing according to FIG. 13.

FIGS. 1 to 12, described together below, show a housing 1 according to the invention in a first embodiment. The housing 1 in the first embodiment comprises exactly one intermediate unit 2, one end unit 52 and one receiving unit 63. The end unit 52 is connected to the intermediate unit 2 by means of screws distributed around the circumference, so that a first housing chamber 84 is formed between the end unit 52 and the intermediate unit 2. The receiving unit 63 is connected to the intermediate unit 2 by means of screws distributed around the circumference, so that a second housing chamber 85 is formed between the receiving unit 63 and the intermediate unit 2. A first energy storage device 87 is accommodated in the first housing chamber 84. A second energy storage device 88 is accommodated in the second housing chamber 85.

The intermediate unit 2 comprises an intermediate element 3, which has a prismatic basic shape, with an H-shaped base face 4 extending along a longitudinal axis 5. The intermediate element 3 is designed as an extruded profile with machined sections and can be made of aluminum in particular. The intermediate element 3 comprises a first side wall 6 and a second side wall 11, which are arranged parallel to each other. A flat support section 16 extends between the first side wall 15 and the second side wall 15′. The first side wall 6 and the second side wall 11 are thus connected to each other via the support section 16. The support section 16 spans a support plane E_T. The center of gravity of a cross-section 15 lies in the support plane E_T with respect to the longitudinal axis 5 through the support section 16.

A first end 7 of the first side wall 6 remote from the support section 16 has a thickened portion terminated by an end contact surface portion 8. A first end 12 of the second side wall 11 remote from the support section 16 has a thickened portion terminated by an end contact surface portion 13. The end contact surface portion 8 of the first end 7 of the first side wall 6 and the end contact surface portion 13 of the first end 12 of the second side wall 11 lie in a common end contact plane E_AB. The end contact plane E_AB is arranged parallel to the support plane E_T and spaced from it by the first amount D1.

A second end 9 of the first side wall 6 remote from the support section 16 has a thickened section which is terminated by a receiving contact surface portion 10. A second end 14 of the second side wall 11 remote from the support section 16 has a thickened section which is terminated by a receiving contact surface portion 15. The receiving contact surface portion 10 of the second end 9 of the first side wall 6 and the receiving contact surface portion 15 of the second end 14 of the second side wall 11 lie in a common receiving contact plane E_AUF.

The receiving contact plane E_AUF is arranged parallel to the support plane E_T and is offset from it by the second amount D2.

In this case, the amounts D1 and D2 are identical. The ratio of the first amount D1 to the second amount D2 is therefore 1. However, it is also conceivable that the aforementioned ratio is at least 0.25, in particular at least 0.3, and/or is less than or equal to 4, in particular less than or equal to 3.

The intermediate unit 2 comprises a first cover element 36 and a second cover element 41. The first cover element 36 is firmly connected to the intermediate element 3 at a first front face of the intermediate element 3. The second cover element 41 is firmly connected to the intermediate element 3 on the opposite second front face. The fixed connection between the first cover element 36 or the second cover element 41 and the intermediate element 3 is realized in the present case by a weld seam, the course of which is described in detail below. Alternatively, it is also conceivable that the fixed connection between the elements is created by a detachable connection, for example by screws. The first cover element 36 and the second cover element 41 together with the intermediate element 3 form a first half-shell open in the direction of the end unit and a second half-shell open in the direction of the receiving unit.

A first end 37 of the first cover element 36 remote from the support section 16 has a third end contact surface portion 38. A first end 42 of the second cover element 41 remote from the support section 16 has a fourth end contact surface portion 43. The third end contact surface portion 38 and the fourth end contact surface portion 43 are located in the end contact plane E_AB. The first end contact surface portion 8, the second end contact surface portion 13, the third end contact surface portion 38 and the fourth end contact surface portion 43 form an annular end contact surface 46 of the intermediate unit 2.

A second end 39 of the first cover element 36 remote from the support section has a third receiving contact surface portion 40. A second end 44 of the second cover element 41 remote from the support section 16 has a fourth receiving contact surface portion 45. The third receiving contact surface portion 40 and the fourth receiving contact surface portion 45 are located in the receiving contact plane E_AUF. The first receiving contact surface portion 10, the second receiving contact surface portion 15, the third receiving contact surface portion 40 and the fourth receiving contact surface portion 45 together form an annular receiving contact surface 47 of the intermediate unit 2.

Cables or piping can extend from the first housing chamber 84 into the second housing chamber 85 via apertures 93 in the support sections 16 of the intermediate elements 3.

The end unit 52 comprises an end element 53, which has a prismatic basic shape with a U-shaped base face. The end element 53 has a first side wall 56, which is arranged parallel to a second side wall 59. A flat end section 62 extends between the first side wall 15 and the second side wall 15′. At an end 57 of the first side wall 56 remote from the end section 62, a widened portion is provided which is delimited by a first end contact surface portion 58. At an end 60 of the second side wall 59 remote from the end section 62, a widened portion is provided which is delimited by a second end contact surface portion 61.

The end unit 52 comprises a first cover element 78 and a second cover element 81. The first cover element 78 is firmly connected to the end element 53 at a first front face of the end element 53. The second cover element 81 is firmly connected to the end element 53 at a second opposite front face of the end element 53. The fixed connection between the first cover element 78 or the second cover element 81 and the end element 53 is realized by a weld seam. Alternatively, it is also conceivable that the fixed connection between the elements is created by a detachable connection, for example by screws. The first cover element 78 and the second cover element 81 together with the end element 53 form a half-shell that is open in the direction towards the intermediate unit 2.

An end 79 of the first cover element 78 remote from the end section 62 has a third end contact surface portion 80. An end 82 of the second cover element 81 remote from the end section 62 has a fourth end contact surface portion 83. The third end contact surface portion 80 and the fourth end contact surface portion 83 are located in the end contact plane E_AB.

The first end contact surface portion 58, the second end contact surface portion 61, the third end contact surface portion 80 and the fourth end contact surface portion 83 of the terminating unit 52 form an annular end contact surface 46′ of the end unit 52.

The end contact surface 46 of the intermediate unit 2 and the end contact surface 46′ of the end unit 52 are connected to each other via a circumferential seal not shown. For this purpose, screw connections are provided between the intermediate unit 2 and the end unit 52, which are distributed around the circumference.

The receiving unit 63 comprises a receiving element 64 that has a prismatic basic shape with a U-shaped base face. The receiving element 64 has a first side wall 65, which is arranged parallel to a second side wall 68. A flat end section 71 extends between the first side wall 65 and the second side wall 68. At an end 66 of the first side wall 65 remote from the end section 71, a widened portion is provided which is delimited by a first receiving contact surface portion 67. At an end 69 of the second side wall 68 remote from the end section 71, a widened portion is provided which is delimited by a second receiving contact surface portion 70.

The receiving unit 63 comprises a first cover element 72 and a second cover element 75. The first cover element 72 is firmly connected to the receiving element 64 at a first front face of the receiving element 64. The second cover element 75 is firmly connected to the receiving element 64 at a second opposite front face of the receiving element 64. The fixed connection between the first cover element 72 or the second cover element 75 and the receiving element 64 is realized by a weld seam. Alternatively, it is also conceivable that the fixed connection between the elements is detachable, for example using screws. The first cover element 72 and the second cover element 75 together with the receiving element 64 form a half-shell that is open in the direction towards the intermediate unit 2.

An end 73 of the first cover element 72 remote from the end section 71 has a third receiving contact surface portion 74. An end 76 of the second cover element 75 remote from the end section 71 has a fourth receiving contact surface portion 77. The third receiving contact surface portion 74 and the fourth receiving contact surface portion 77 are located in the receiving contact plane E_AUF. The first receiving contact surface portion 40, the second receiving contact surface portion 45, the third receiving contact surface portion 74 and the fourth receiving contact surface portion 77 of the receiving unit 63 form an annular receiving contact surface 47′ of the receiving unit 63.

The receiving contact surface 47 of the intermediate unit 2 and the receiving contact surface 47′ of the receiving unit 63 are connected to each other via a circumferential seal that is not shown. For this purpose, screw connections are provided between the intermediate unit 2 and the receiving unit 63.

A channel 17 is integrated in the support section 16. The channel 17 comprises a first channel section 18, a second channel section 19, a third channel section 20 and a fourth channel section 21, which each extend parallel to the longitudinal axis 5 and are fluidically connected to one another. The first channel section 18 in is delimited by a first boundary wall 22 and a first partition wall 23. The second channel section 19 is delimited by the first partition wall 23 and a second partition wall 23′. The third channel section 20 is delimited by the second partition wall 23′ and a third partition wall 23″. The fourth channel section 21 is delimited by the third partition wall 23″ and a second boundary wall 22′. In this case, the four channel sections 18, 19, 20 and 21 are identical in width. However, it is also conceivable that the channel sections 18, 19, 20, 21 are designed with different widths, for example to optimize the flow behavior of the coolant.

A dividing rib 24 is arranged in each of the four channel sections 18, 19, 20, 21 and extends parallel to the longitudinal axis 5. The dividing ribs 24 thus divide each of the four channel sections 18, 19, 20, 21 into two channel sections. In this case, the channel sections are identical in width. However, it is also conceivable that the channel sections are designed with different widths, for example to optimize the flow behavior of coolant.

The channel 17 comprises an inlet opening 26 at an inlet end 25. The inlet end 25 is formed by the first channel section 18. The channel 17 comprises an outlet opening 28 at an outlet end 27. The outlet end 27 is formed by the fourth channel section 21. The inlet opening 26 is fluidically connected to the outlet opening 28 via the four channel sections 18, 19, 20, 21.

The first cover element 36 comprises an inlet aperture 48, which is directly adjacent to the inlet opening 26 of the channel 17 and merges into it. Coolant can thus be supplied to the channel 17 via the inlet aperture 48. For this purpose, connection means for external lines can be provided in the inlet aperture 48. To optimize the flow, the inlet aperture 48 is essentially conical, with the cone widening in the direction towards the inlet opening 26 of the channel 17.

The first cover element 36 also comprises an outlet aperture 49, which is directly adjacent to the outlet opening 28 of the channel 17 and merges into it. Coolant can therefore be removed from the channel 17 via the outlet aperture 49. For this purpose, connection means for external lines can be provided in the outlet aperture 49. To optimize the flow, the outlet aperture 49 is essentially conical, with the cone widening in the direction towards the outlet opening 28.

The inlet aperture 48 and the outlet aperture 49 are fluidically connected to each other via the channel 17. The inlet aperture 48 and the outlet aperture 49 are arranged so that they are each intersected by the support plane E_T. In other words, the inlet aperture 48 and the outlet aperture 49 are located at least partially in the support plane E_T. The inlet aperture 48 and the outlet aperture 49 are arranged outside the end contact plane E_AB and the receiving contact plane E_AUF.

The first channel section 18 comprises an inlet manifold section 31 adjacent to the inlet opening 26 and a connection manifold section 32 at a connection end 29. The second channel section 19 comprises a connection manifold section 32′ at one end, which merges into the connection manifold section 32 of the first channel section 18. The second channel section 19 comprises a connection manifold section 33 at a further end. The third channel section 20 comprises a connection manifold section 33′ at one end 10, which merges into the connection manifold section 33 of the second channel section 19. The third channel section 20 comprises a connection manifold section 34 at a further end. The fourth channel section 21 comprises a connection manifold section 34′ at a connection end 30, which merges into the connection manifold section 34 of the third channel section 20. The fourth channel section 21 comprises an outlet manifold section 35 adjacent to the outlet opening 28.

The inlet manifold section 31, the connecting manifold sections 32, 32′, 33, 33′, 34, 34′ and the outlet manifold section 35 are each formed by recesses in the channel 17. Here, the partition walls 23, 23′, 23″ and the dividing ribs 24, 24′, which extend from one front face of the intermediate element 3 to the other front face in a semi-finished state of the intermediate element 3, are removed in the respective areas of the manifold section. This can be done, for example, by inserting a finger cutter into channel 17.

As can be seen in particular in FIG. 7, in which the flow paths of coolant between the inlet opening 26 and the outlet opening 28 are shown schematically with dash-dotted arrows, the coolant meanders back and forth between the two front faces of the intermediate element 3. Due to the even number of channel sections, the coolant enters the channel 17 on the same front face of the intermediate element 3 through the inlet opening 26 as it exits through the outlet opening 28. It is understood that the number of channel sections can be freely selected, whereby the outlet of the coolant at the opposite front faces of the intermediate element 3 can be realized in particular by an uneven number of channel sections.

FIGS. 8 to 12 illustrate the course of the weld seam between the intermediate element 3 and the cover elements 36, 37 of the intermediate unit 2. The associated explanations apply analogously to the connection of the end element 53 to the cover elements 78, 81 of the end unit 52 and to the connection of the receiving element 64 to the cover elements 72, 75 of the receiving unit 63.

A main weld seam runs along the outer circumferential edge of the base face 4 or end surface of the intermediate element 3 shown in FIGS. 8 and 10. The base face 4 is shown hatched in FIGS. 8 and 10 for the sake of clarity. The main weld seam thus circumscribes an essentially H-shaped surface that corresponds to the end face or base face of the intermediate element 3. In other words, the main weld seam defines an essentially H-shaped area that corresponds to the front face or base face of the intermediate element. By welding the intermediate element 3 to the first cover element 36 on a front face and the second cover element 41 on the opposite front face 20, in each case with the main weld seam, a secure connection between the intermediate element 3 and the two cover elements can be ensured. On the other hand, the first half-shell of the intermediate unit 2, which is open in the direction towards the end unit 2, and the second half-shell of the intermediate unit 2, which is open in the direction towards the receiving unit 63, can be sealed off from one another by the aforementioned welding.

In addition, two further auxiliary weld seams are provided between the intermediate element 3 and the respective cover element. For this purpose, for example, a first welding aperture 50 and a second welding aperture 51 are provided in the first cover element 36, which extend at least over the thickness of the support section 16. An auxiliary weld seam can thus be provided in the first welding aperture 50 and the second welding aperture 51, which connects an upper section of the main weld seam to a lower section of the main weld seam.

The two auxiliary weld seams frame the channel 17 together with the main weld seam so that an effective seal of the channel 17 is ensured. For this purpose, the first welding aperture 50 and the second welding aperture 51 are arranged in such a way that the channel 17 lies completely between them in a projection along the longitudinal axis 5. The welding of the intermediate element 3 to the first cover element 36 on a front face and the second cover element 41 on the opposite front face, in each case with the combination of main weld seam and auxiliary weld seams, can thus ensure a seal of the channel 17 with respect to the first half-shell of the intermediate unit 2, which is open in the direction towards the end unit 52, and the second half-shell of the intermediate unit 2, which is open in the direction towards the receiving unit 63.

FIGS. 13 to 15, which are described together below, show a housing 1′ according to the invention in a second embodiment. The second embodiment differs essentially from the first embodiment in that a second intermediate unit 2′ is provided between the first intermediate unit 2 and the receiving unit 63. With regard to the common features of the second embodiment, reference is made to the explanation of the first embodiment. Identical or corresponding elements are designated with the same reference signs.

The housing 1′ comprises a first intermediate unit 2 and a second intermediate unit 2′, an end unit 52 and a receiving unit 63. The end unit 52 is connected to the first intermediate unit 2 via screws, so that a first housing chamber 84 is formed between the end unit 52 and the first intermediate unit 2. The first intermediate unit 2 is connected to the second intermediate unit 2′, so that a second housing chamber 85 is formed between the first intermediate unit 2 and the second intermediate unit 2′. The second intermediate unit 2′ is connected to the receiving unit 63, so that a third housing chamber 86 is formed between the second intermediate unit 2 and the receiving unit 63. A first energy storage device 87 is arranged in the first housing chamber 84. A second energy storage device 88 is arranged in the second housing chamber 85. A third energy storage device 89 is arranged in the third housing chamber 86. The skilled person can thus see that the housing 1 has a modular structure and can be extended by further intermediate units 2. Each additional intermediate unit represents the intermediate unit of a receiving unit above it.

FIG. 13 shows that the cover element 41 comprises three apertures 90, 91, 92 5 in which interfaces can be arranged via which the energy of the energy storage devices can be released or via which energy can be supplied to the energy storage devices. It is also conceivable that the energy storage devices can be connected to a control arrangement not shown via the apertures 90, 91, 92.

### LIST OF REFERENCE SIGNS

1 Housing
2 Intermediate unit
3 Intermediate element
4 Base face
5 Longitudinal axis
6 Side wall
7 End of the side wall
8 End contact surface portion
9 End of the side wall
10 Receiving contact surface portion
11 Side wall
12 End of the side wall
13 End contact surface portion
14 End of the side wall
15 Receiving contact surface portion
16 Support section
17 Channel
18 Channel section
19 Channel section
20 Channel section
21 Channel section
22 Boundary wall
23 Partition wall
24 Dividing rib
25 Inlet end
26 Inlet opening
27 Outlet end
28 Outlet opening
29 Connecting end
30 Connecting end
31 Inlet manifold section
32 Connection manifold section
33 Connection manifold section
34 Connection manifold section
35 Outlet manifold section
36 Cover element
37 End of the cover element
38 End contact surface portion
39 End of the cover element
40 Receiving contact surface portion
41 Cover element
42 End of the cover element
43 End contact surface portion
44 End of the cover element
45 Receiving contact surface portion
46 End contact surface
47 Receiving contact surface
48 Inlet aperture
49 Outlet aperture
50 Welding aperture
51 Welding aperture
52 End unit
53 End element
56 Side wall
57 End of the side wall
58 End contact surface portion
59 Side wall
60 End of the side wall
61 End contact surface portion
62 End section
63 Receiving unit
64 Receiving element
65 Side wall
66 End of the side wall
67 Receiving contact surface portion
68 Side wall
69 End of the side wall
70 Receiving contact surface portion
71 End section
72 Cover element
73 End of the cover element
74 Receiving contact surface portion
75 Cover element
76 End of the cover element
77 Receiving contact surface portion
78 Cover element
79 End of the cover element
80 End contact surface portion
81 Cover element
82 End of the cover element
83 End contact surface portion
84 Housing chamber
85 Housing chamber
86 Housing chamber
87 Energy storage device
88 Energy storage device
89 Energy storage device
90 Aperture
91 Aperture
92 Aperture
E_T Support plane
E_AB End contact plane
E_UP Receiving contact plane
D Distance

1. Housing, in particular for an energy storage device:
an intermediate unit (2) with an intermediate element (3) in the form of a prism with an H-shaped base face (4) and a longitudinal axis (5),
wherein the intermediate element (3) has a first side wall (6) on a first longitudinal side and a second side wall (11) on a second longitudinal side, between which a support section (16) extends, which spans a support plane (E_T), and
a end unit (52),
wherein the intermediate element (3) is connected to the end unit (52) at a respective first end (7, 12) of the first side wall (6) and the second side wall (11) remote from the support section (16) in such a way that a first housing chamber (84) is formed between the intermediate unit (2) and the end unit (52).

2. Housing according to claim 1,
characterized in that the first end (7) of the first side wall (6) remote from the support section (16) has a first end contact surface portion (8) connected to the end unit (52); and
that the first end (12) of the second side wall (11) remote from the support section (16) has a second end contact surface portion (13) which is connected to the end unit (52),
wherein the first end contact surface portion (8) and the second end contact surface portion (13) lie in an end contact plane (E_AB).

3. Housing according to one of claims 1 to 2,
characterized in that the intermediate element (3) is connected to a receiving unit (63) at a respective second end (9, 14) of the first side wall (6) and the second side wall (11) opposite the first end (7, 12),
wherein a second housing chamber (84) is formed between the intermediate unit (2) and the receiving unit (63).

4. Housing according to claim 3,
characterized in that the second end (9) of the first side wall (7) has a first receiving contact surface portion (10) connected to the receiving unit (63); and
that the second end (14) of the second side wall (11) has a second receiving contact surface portion (15) which is connected to the receiving unit (63),
wherein the first receiving contact surface portion (10) and the second receiving contact surface portion (15) lie in a receiving contact plane (E_AUF).

5. Housing according to claim 4,
characterized in that the end contact plane (E_AB) and the support plane (E_T) are arranged in parallel and spaced apart from one another by a first amount (D1), and
that the receiving contact plane (E_AUF) and the support plane (E_T) are arranged parallel and spaced apart by a second amount (D2),
wherein in particular the ratio of the first amount (D1) to the second amount (D2) is at least 0.25, in particular at least 0.3, and
the ratio of the first amount (D1) to the second amount (D2) is less than or equal to 4, in particular less than or equal to 3.

6. Housing according to one of claims 1 to 5,
characterized in that the support section (16) comprises a channel (17) which runs parallel to the longitudinal axis (5) at least partially.

7. Housing according to claim 6,
characterized in that the channel (17) comprises a first channel section (18), which has an inlet opening (26) at an inlet end (25), and a further channel section (21), which has an outlet opening (28) at an outlet end (27),
wherein the first channel section (18) is fluidically connected at a connection end (29) to a connection end (30) of the further channel section (21).

8. Housing according to claim 7,
characterized in that the first channel section (18) comprises an inlet manifold section (31) adjacent to the inlet opening (26) and a connection manifold section (32) at the connection end (29), and
that the further channel section (21) comprises an outlet manifold section (35) adjoining the outlet opening (28) and a connection manifold section (34′) at the connection end (30),
wherein the connection manifold section (32) of the first channel section (18) is fluidically connected to the connection manifold section (34′) of the further channel section (21) and, in particular, is integrally formed therewith.

9. Housing according to claim 8,
characterized in that the inlet manifold section (31) and/or the connection manifold section (32) of the first channel section (18) is formed by a recess of the first channel section (18); and/or
that the outlet manifold section (35) and/or the connection manifold section (34′) of the further channel section (21) is formed by a recess in the further channel section (21).

10. Housing according to one of claims 1 to 9,
characterized in that the intermediate unit (2) comprises a first cover element (36) and a second cover element (41),
wherein the first cover element (36) is connected to the intermediate element (3) at a first front face of the intermediate element (3) and the second cover element (41) is connected to the intermediate element (3) at a second front face opposite the first front face.

11. Housing according to claim 10,
characterized in that a first end (37) of the first cover element (36) remote from the support section (16) has a third end contact surface portion (38) connected to the end unit (52); and
a first end (42) of the second cover element (41) remote from the support section (16) has a fourth end contact surface portion (43) connected to the end unit (52);
wherein
the third end contact surface portion (38) and the fourth end contact surface portion (43) lie in the end contact plane (E_AB) and, in particular, form an annular end contact surface (46) with the first end contact surface portion (8) and the second end contact surface portion (13).

12. Housing according to one of claims 10 or 11,
characterized in that a second end (39) of the first cover element (36) remote from the support section (16) has a third receiving contact surface portion (40) connected to the receiving unit (63); and
a second end (44) of the second cover element (41) remote from the support section (16) has a fourth receiving contact surface portion (45) which is connected to the receiving unit (63);
wherein the third receiving contact surface portion (40) and the fourth receiving contact surface portion (45) lie in the receiving contact plane (E_AUF) and in particular form an annular receiving contact surface (47) with the first receiving contact surface portion (10) and the second receiving contact surface portion (15).

13. Housing according to one of claims 10 to 12,
characterized in that one of the first cover element (36) and the second cover element (41) comprises an inlet aperture (48) which is directly adjacent to and merges into the inlet opening (26) of the channel (17), and
that one of the first cover element (36) and the second cover element (41) comprises an outlet aperture (49) which is directly adjacent to and merges into the outlet opening (28) of the channel (17),
wherein the inlet aperture (48) and the outlet aperture (49) are each intersected by the support plane (E_T) and are arranged outside the end contact plane (E_AB) and the receiving contact plane (E_AUF).

14. Housing according to one of claims 10 to 13,
characterized in that the first cover element (36) and/or the second cover element (41) comprises a first welding aperture (50) and/or a second welding aperture (51), which are each arranged in overlap with the support section (16).

15. Housing according to claim 14,
characterized in that the channel (17) is arranged between the first welding aperture (50) and the second welding aperture (51).
